(19) United States
(12) Patent Application Publication
(10) Pub. No.: US 2014/0255879 A1
(43) Pub. Date: Sep. 11, 2014

(54) FLIGHT-ICING SIMULATOR

(71) Applicant: Ming Lu, Tianjin (CN)

(72) Inventor: Ming Lu, Tianjin (CN)

(21) Appl. No.: 13/885,198

(22) PCT Filed: May 7, 2012
(86) PCT No.: PCT/CN2012/075117

§ 371 Date: May 14, 2013

(30) Foreign Application Priority Data
Nov. 29, 2011 (CN) 201110385719.8

(51) Int. Cl. G09B 9/08

(52) U.S. Cl. CPC G09B 9/085
USPC 434/45

(57) ABSTRACT

This invention supplies a flight-icing simulator to train the pilots with skills under flight-icing conditions. This simulator is composed of several modules to provide pilots the information of ice distribution and strength on aircrafts, the distance of the aircraft to the icing dangerous zone, the perturbation of the points with feedback function, etc.

### TECHNICAL FIELD OF THE INVENTION

This invention relates aerospace domain. Particularly, it is a flight-icing simulator for simulating the state of an aircraft being or being on the point of icing in flight. It is used to train pilots to control and take steps under this state.

### TECHNICAL BACKGROUND

At a certain attitude, the SWD (Supercooled Water Droplets) in atmosphere, which are at temperature below the freezing point but exist in form of particles, may impact on the surfaces of flying aircrafts. If the LWC (Liquefied Water Content) of SWD in atmosphere is high, the water film can adhere on aircraft surfaces and accrete into ice if aircraft flying attitude is up to 4000 meters. This phenomenon is called the flight-icing. Ice accretion on some critical control surfaces of aircraft, such as wing, stabilizer, engine inlet, engine blades, etc. has a significant impact on operation and controllability of aircraft. For examples, it may shift the gravity center of aircraft, freeze movable components, result in substantial decrease of lift and increase in drag, reduce stall margin. The accreted ice on the nacelle in front of engine may be ingested into engine inlet causing thrust loss even flame out. According to statistics of aircraft flight safety, the flight-icing cases count more than 60% of aviation disaster.

Modern aircrafts generally install the de-icing system, which routinely starts the electrical heating equipment through the control of the feedback from the icing sensors on the critical surfaces of aircraft, to finish the de- and anti-icing work for aircrafts in flight and. Statistically showing that the de-icing system keeps about 80% aircraft flying time means that the possibility of flight-icing for aircrafts is very high.

For flight safety, aircrafts must fly in a safe mode when encountering the flight-icing conditions in atmosphere. Modern aircrafts fly under Instrument flight rule (IFR), which demands the pilots to follow all kinds of commands from instruments or control aircrafts in an automatic mode. When aircrafts meet the flight-icing conditions, the pilots and the de-icing systems must execute their different tasks. It is necessary to train the pilots the ability to accomplish the tasks in the same situations as in flight. The purpose of this invention is to improve pilots' ability to correctly evaluate, judge situations and execute corresponding operations. The training gives the pilots the memory and feeling of operation sequence through supplying the different visual signals. Besides, the training can build for the pilots a spectacle of pressure and affection under flight-icing in mentality.

Supply a simulator with functions mentioned above for training pilots in land is very important. It is called the flight-icing simulator.

### SUMMARY OF THE INVENTION

This invention supplies a flight-icing simulator to train the pilots with skills under flight-icing conditions, such as to do de-icing operation and avoid dangerousness. This simulator provides pilots the information of ice distribution and strength on aircrafts, the distance of the aircraft to the icing dangerous zone, the perturbation of the points with feedback function. This simulator is composed of several modules. Those modules and their functions are described following.
SM (Startup Module), which can select one training scheme and start all other modules.
ACDM (Atmosphere Condition Database Module), which storages database of LWC, SWD scale distribution, atmosphere pressure, convection velocity, temperature and humidity, etc.
FPMM (Flying Parameter Memory Module), which storages different aircraft configurations, flying state information, such as flight attitude, speed, accelerated speed, angle of attack, angle of deviation, angle of roll, etc. for different aircrafts.
FSSM (Flight-icing State Simulation Module), which calculates ice distribution and strength based on information from ACDM and FPMM. This module includes the following four units.
   (1) OSOBMU (Original Snapshot's Orthogonal Base Memory Unit)
   (2) OSCCMMU (Original Snapshot's Characteristic Coefficient Matrix Memory Unit)
   (3) IU (Interpolation Unit)
   (4) ISCU (Icing State Calculation Unit)
ISMSM (Icing Sensor Matrix Simulation Module), which calculates the variation of the vibration frequency of the vibrator of the virtual icing sensors arranged on the critical points of aircraft surfaces based on information from FSSM.
FESM (Flight-icing Effect Simulation Module), which calculates the additional force and momentum acting on aircraft induced by flight-icing. This module includes the following three units.
   (1) LPSU (Loading Point Selection Unit)
   (2) FIU (Force Integration Unit)
   (3) MIU (Momentum Integration Unit)
ASM (Alarm Simulation Module), which starts an alarm system according to safety judgment criterion comparing to information of icing distribution and strength from FSSM.
EHDSM (Electrical Heating De-icing Simulation Module), which determines the output heat to do de-icing based on the predicted amount of ice in FSSM and ASM. This module includes the following three units.
   (1) MSHTCU (Metal Skin Heat Transfer Calculation Unit)
   (2) ILHCCU (Ice Layer Heat Conduction Calculation Unit)
   (3) DECU (De-icing Effect Calculation Unit)
DCM (Distance Calculation Module), which calculates the distance to the icing dangerous zone. This module includes the following three units.
   (1) DU (Database Unit for the relationship of air convection velocity and LWC of SWD)
   (2) IU (Interpolation Unit)
   (3) DCU (Distance Calculation Unit)
VSM (Visual Simulation Module), which presents cloud and ice layer on aircraft surface based on type of aircraft in FPMM and predicted ice distribution in FSSM and ASM.
PWAM (Pilot Work Area Module), which is a real motor driven chair.
AIPM (Aviation Instrument Panel Module), which is a real aviation instrument panel including the screen displaying information from ASM an EHDSM's running
DDTSM (Dynamic Data Transmission Simulation Module), which transfers all signals about flying state and other information such as force, momentum to VSM, PWAM, AIPM, etc.
BBM (Black Box Module), which functions to record all the information in flight.

### BRIEF DESCRIPTION OF FIGURES

FIG. 1 the connection relation among all the modules in flight-icing simulator

FIG. 2 the connection of different units in FSSM 4

FIG. 3 the relationship of the units in EHDSM 9

### DETAILED DESCRIPTION OF THE PREFERRED EMBODIMENT

An embodiment of a flight-icing simulator according to the invention is illustrated following. It is a simulator to train pilots skills under flight-icing conditions.

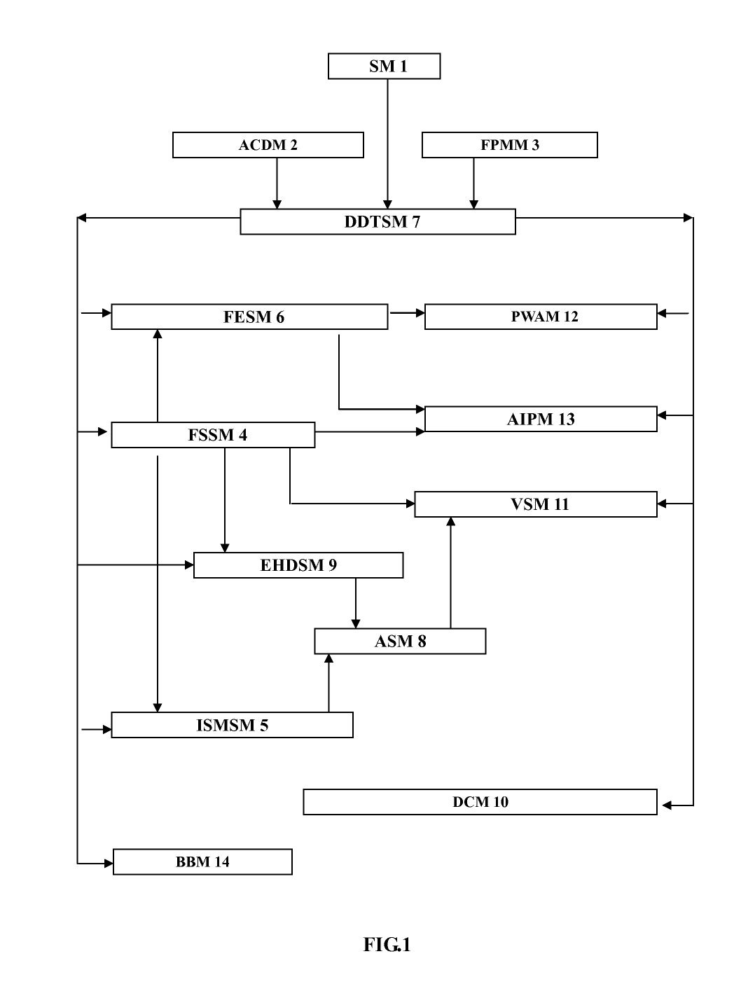

The FIG. 1 illustrates the connection relation among all the modules in this simulator, where includes SM (Startup Module) 1, ACDM (Atmosphere Condition Database Module) 2, FPMM (Flying Parameter Memory Module) 3, FSSM (Flight-icing State Simulation Module) 4, ISMSM (Icing Sensor Matrix Simulation Module) 5, FESM (Flight-icing Effect Simulation Module) 6, DDTSM (Dynamic Data Transmission Simulation Module) 7, ASM (Alarm Simulation Module) 8, EHDSM (Electrical Heating De-icing Simulation Module) 9, DCM (Distance Calculation Module) 10, VSM (Visual Simulation Module) 11, PWAM (Pilot Work Area Module) 12, AIPM (Aviation Instrument Panel Module) 13, BBM (Black Box Module) 14.
SM 1 has a delay circuit, which firstly functions to load power, reset, warm up for all other modules. After this task, it comes into a selection mode, which decides precision, error level, sampling interval, heating method, atmosphere conditions, aircraft type, flying state, and training case. Finally, it set an initial time as timing reference for simulation.
ACDM 2 storages database including LWC, SWD scale distribution, atmosphere pressure, convection velocity, temperature and humidity in three-dimensional spatial grid points with 1 killermeter increment. The spatial domain is large enough to cover the aircraft flying range during the flight-icing simulation. For the different training case, there exists the refined database backup of atmosphere condition from interpolation.
FPMM 3 storages different aircraft configurations and locations of force and icing sensor in three-dimensional curved surface grid points. It also saves flying state information, such as flight attitude, speed, accelerated speed, angle of attack, angle of deviation, angle of roll. there exists the refined database backup of curved surface grid points from interpolation.
FSSM 4 calculates ice distribution and strength from information from ACDM 2 and FPMM 3. The calculation gives the results within the sampling interval decided by SM 1. The results are presented as the form of data table built by the ice thickness on the three-dimensional grid points on aircraft surface and time points during the sampling interval. Some results for those points locating the icing sensor are tabled extra. This module includes the following four units: OSOBMU(Original Snapshot's Orthogonal Base Memory Unit), OSCCMMU(Original Snapshot's Characteristic Coefficient Matrix Memory Unit), IU (Interpolation Unit), and ISCU(Icing State Calculation Unit).

The so-called original snapshot is a set of data from test in flight, wind tunnel test and numerical simulation based on computational fluid dynamics. The original snapshot for the flight-icing is in the form of multi-dimensional data array about iced aircraft surface coordinators. For example, a variable set of an original snapshot is written as the form of

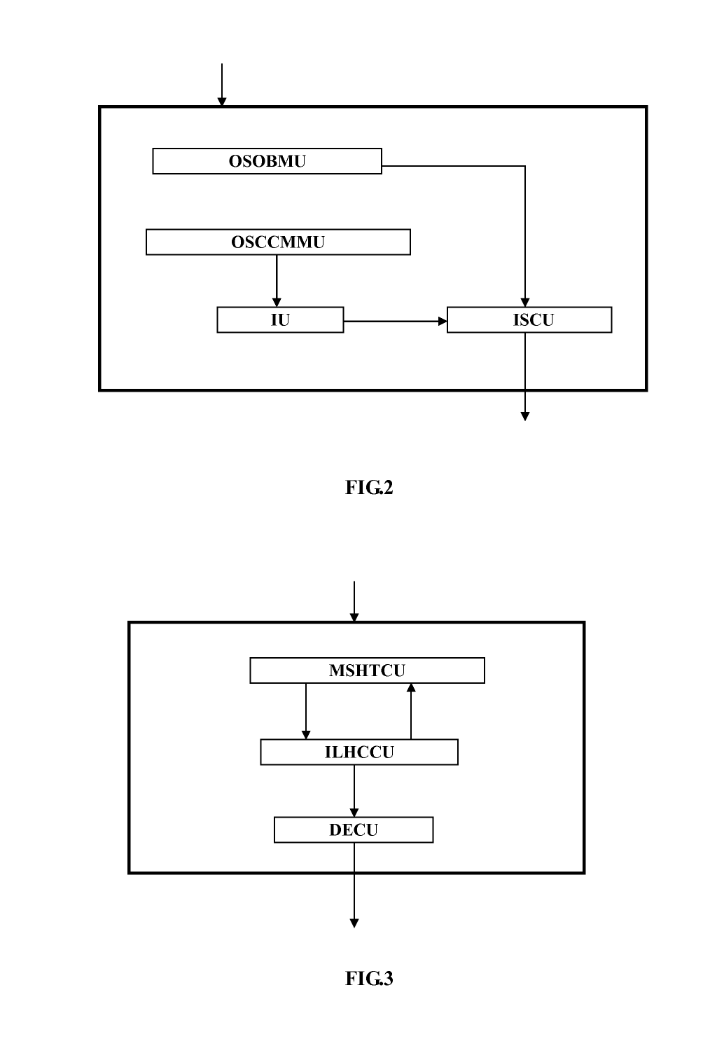

{Uⁱⱼ}, i=1,2, . . . ,ns, j=1,2, . . . , N, (1)

where ns is the number of the original snapshot; N is the number of points. Formally, the original snapshot is composed of ns sets of N-dimensional vector. For each vector, U is the coordinate vector of aircraft surface points. The dimension for each vector {Uⁱⱼ} should be m·N, where m is the dimension of U. the original snapshot itself constructs several training cases and the interpolation operation to them can takes shape the flight-icing state under different flight conditions. The FIG. 2 illustrates the connection of different units in this module.

OSOBMU storages the set of original snapshot's orthogonal base matrix, which are ns sets of N-dimensional orthogonal base vector. formally, it is

{φⁱⱼ}, i=1,2, . . . ,ns, j=1,2, . . . , N, (2)

OSCCMMU storages the original snapshot's characteristic coefficient matrix, which is a ns rows and ns columns square matrix. Specially, it is

$$[ \begin{matrix}{α}_{1}^{1} & {α}_{2}^{1} & ⋮ & ⋮ & ⋮ & {α}_{ns}^{1} \\ {α}_{1}^{2} & {α}_{2}^{2} & ⋮ & ⋮ & ⋮ & {α}_{ns}^{2} \\ ⋮ & ⋮ & & & & ⋮ \\ ⋮ & ⋮ & & & & ⋮ \\ ⋮ & ⋮ & & & & ⋮ \\ {α}_{1}^{ns} & {α}_{2}^{ns} & ⋮ & ⋮ & ⋮ & {α}_{ns}^{ns}\end{matrix} ] . \qquad ( 3 )$$

IU runs interpolation operation to the original snapshot's characteristic coefficient in OSCCMMU, if the selected training case is not one of the original snapshots, based on the data from ACDM 2 and FPMM 3, to find the characteristic coefficient α₁^{k},α₂^{k}, . . . αₙₛ^{k} for new training case.

ISCU finds the iced aircraft surface coordinators by multiplying the interpolated characteristic coefficient α₁^{k},α₂^{k}, . . . αₙₛ^{k} in IU with the original snapshot's orthogonal base in OSOBMU, which means

$$\{ {U}_{j}^{k} \} = {\sum }_{i = 1}^{ns} {α}_{i}^{k} \{ {ϕ}_{j}^{k} \} , \\ j = 1 , N . \qquad ( 4 )$$

The accuracy of all mathematic operation is decided in SM 1. Since the time delay used for calculation in this module makes the flight-icing prediction cannot work in real-time, it needs to be recorded. The ice capacity on aircraft surfaces is discretized at the points matched with heater. A table constructed with the heater number list and the discretized ice capacity is generated; then it is sent to EHDSM 9.
ISMSM 5, receiving information from SM 1, ACDM 2, FPMM 3, and FSSM 4, simulates the ice distribution and strength on the points of icing sensors. The working principle of real icing sensor is that icing can change the vibration frequency of the vibrator of the icing sensor. In the invention, the virtual icing sensor is a circuit which is pre-calibrated according to the relationship of the icing capacity and the vibration frequency of the vibrator. The circuit is input the information about the icing capacity calculated in FSSM 4 and outputs the analogy quantity about vibration frequency. The analogy quantity is sent to ASM 8 and AIPM 13.
FESM 6, receiving information from SM 1, ACDM 2, FPMM 3, and FSSM 4, calculates the additional force and momentum acting on aircraft induced by flight-icing and sends the results to PWAM 12 and AIPM 13. This module includes the following three units: LPSU (Loading Point Selection Unit), FIU (Force Integration Unit), and MIU (Momentum Integration Unit). LPSU transfers the information from ISMSM 5 into volume and weight at each point. FIU integrate all the weight to get the whole force induced by icing. MIU calculates momentum around aerodynamic center of aircraft.
ASM 8 starts an alarm circuit when the voltage value input presenting the vibration frequency of icing sensor vibrator from ISMSM 5 is higher than the value of safety voltage. The alarm time needs to be recorded, since the time delay in FSSM 4 needs to be removed from the alarm time to catch up real-time alarm like real aircraft under flight-icing. The real icing capacity on aircraft surface should be modified according to time reduction, which can be fulfilled by using backward interpolation of data in each icing sensors along time sequence. The modified data are sent to VSM 11 and AIPM 13.
EHDSM 9 determines the output heat to do de-icing based on the predicted amount of ice in FSSM 4. There are two heating modes. The steady mode doesn't consider the new ice increasing during heating; while the dynamic mode needs to do it. This module includes the following three units: MSHTCU(Metal Skin Heat Transfer Calculation Unit), ILHCCU(Ice Layer Heat Conduction Calculation Unit), and DECU(Deicing Effect Calculation Unit). The FIG. 3 shows the relationship of the units in this module. MSHTCU simulates heat conduction and a conjugate heat transfer processes. Heating comes under metal skin inside where temperature distribution is linear. At the interface of metal skin and ice, heat is transferred reciprocally, which is conjugate heat transfer. ILHCCU simulates a heat transfer where temperature distribution inside ice layer is linear and the temperature at the interface of ice and air is atmosphere one. DECU feeds back the voltage values indicating the change of ice capacity during heating period to ASM 8, which judges the electrical heat is to be shut down when the voltage values is lower than the safety value.
DCM 10 calculates the distance to the icing dangerous zone through information from SM 1, ACDM 2, FPMM 3 and sends result to AIPM 13. This module includes three units: DU(Database Unit for the relationship of air convection velocity and LWC of SWD), IU(Interpolation Unit), and DCU(Distance Calculation Unit). DU storages the convection velocity of atmosphere and LWC of SWD in three-dimensional grid points with interval of 1 kilometer. IU finds above values for specified training case by interpolation in DU based on information from SM 1, ACDM 2, and FPMM 3. DCU calculates the distance from starting position of simulation at staring time to the position where the LWC of SWD is high enough up to the icing conditions and sends the result to AIPM 13.
VSM 11 displays cloud and ice layer on aircraft based on information from SM 1, ACDM 2, FPMM 3, FSSM 4, ISMSM 5, and FESM 6 on screen, where the icing zone's color is white and non-icing zone's color is grey. Displayed time is local time.
PWAM 12 is a motor driven chair, which can pitch and row according to data of force and momentum from FESM 6.
AIPM 13 displays information and data from SM 1, ACDM 2, FPMM 3, FSSM 4, ISMSM 5, FESM 6 ASM 8, EHDSM 9, DCM 10.
BBM 14 records all information in flight.
DDTSM transfers all signals about flying state and other information such as force, momentum to VSM 11, PWAM 12, AIPM 13. All data and information transfer among all modules and units is implemented with this module.

1. A flight-icing simulator, for simulating the state of an aircraft being or being on the point of icing in flight and is used to train pilots to control and take steps under this state, includes the following modules
SM (Startup Module) 1;
ACDM (Atmosphere Condition Database Module) 2;
FPMM (Flying Parameter Memory Module) 3;
FSSM (Flight-icing State Simulation Module) 4;
ISMSM (Icing Sensor Matrix Simulation Module) 5;
FESM (Flight-icing Effect Simulation Module) 6;
DDTSM (Dynamic Data Transmission Simulation Module) 7;
ASM (Alarm Simulation Module) 8;
EHDSM (Electrical Heating De-icing Simulation Module) 9;
DCM (Distance Calculation Module) 10;
VSM (Visual Simulation Module) 11;
PWAM (Pilot Work Area Module) 12;
AIPM (Aviation Instrument Panel Module) 13;
BBM (Black Box Module) 14.

2. A flight-icing simulator according to claim 1 wherein said FSSM(Flight-icing State Simulation Module) 4 includes the following four units
OSOBMU (Original Snapshot's Orthogonal Base Memory Unit);
OSCCMMU (Original Snapshot's Characteristic Coefficient Matrix Memory Unit);
IU (Interpolation Unit);
ISCU (Icing State Calculation Unit).

3. A flight-icing simulator according to claim 1 wherein said FESM(Flight-icing Effect Simulation Module) 6 includes the following three units
LPSU (Loading Point Selection Unit)
FIU (Force Integration Unit);
MIU (Momentum Integration Unit).

4. A flight-icing simulator according to claim 1 wherein said EHDSM (Electrical Heating De-icing Simulation Module) 9 includes the following three units
MSHTCU (Metal Skin Heat Transfer Calculation Unit);
ILHCCU (Ice Layer Heat Conduction Calculation Unit);
DECU (Deicing Effect Calculation Unit).

5. A flight-icing simulator according to claim 1 wherein said DCM(Distance Calculation Module) 10 includes the following three units
DU (Database Unit for the relationship of air convection velocity and LWC of SWD);
IU (Interpolation Unit);
DCU (Distance Calculation Unit).
